(19) United States
(12) Patent Application Publication
(10) Pub. No.: US 2012/0037491 A1
(43) Pub. Date: Feb. 16, 2012

(54) ANTENNA FOR INDUCTIVELY COUPLED PLASMA GENERATION, INDUCTIVELY COUPLED PLASMA GENERATOR, AND METHOD OF DRIVING THE SAME

(76) Inventors: Young June Park, Seoul (KR); Il Wook Kim, Seoul (KR)

(21) Appl. No.: 13/145,964

(22) PCT Filed: Jan. 22, 2010
(86) PCT No.: PCT/KR2010/000417

§ 371 Date: Oct. 7, 2011

(30) Foreign Application Priority Data
Jan. 22, 2009 (KR) 10-2009-0005335

(51) Int. Cl. H05H 1/50; C23F 1/08; H05H 1/46; H01F 27/28

(52) U.S. Cl. 204/156; 336/215; 156/345.1

(57) ABSTRACT

In one embodiment, the antenna for inductively coupled plasma generation includes a first end connected to an alternating current (AC) power supply, a second end connected to a ground terminal, and an antenna coil unit connected to the first end and the second end and configured to generate an induced electric field when power of the AC power supply is applied. The antenna coil unit includes one or more sub-coil units. The one or more sub-coil units generate a magnetic field in a region adjacent to the antenna coil unit in response to the applied power.

### TECHNICAL FIELD

The described technology relates generally to an antenna for inductively coupled plasma generation, an inductively coupled plasma generator, and a method of driving the same, and more particularly, to an inductively coupled plasma generating antenna having at least one sub-antenna coil, a plasma generator having the inductively-coupled plasma generating antenna, and a method of driving the plasma generator.

### BACKGROUND ART

Plasma generators are used to perform various surface treatment processes, such as etching, chemical vapor deposition (CVD), sputtering, oxidation and nitridation, in technical fields for semiconductor wafers or flat panel displays (FPDs) in which micropatterns should be formed. Lately, wafers for semiconductor device and substrates for FPDs have increased in size to, for example, 450 mm or more to reduce cost and improve throughput, and demand for a plasma generator for processing large wafers or substrates is increasing.

In general, plasma generators are classified into inductively coupled plasma generators, capacitively coupled plasma generators, and so on. In a method of driving inductively coupled plasma generators, antennas for plasma generation are disposed around a chamber, and high frequency or radio frequency (RF) power is applied to the antennas to form a magnetic field that varies according to time in a space surrounding the chamber. The magnetic field varying according to time forms an induced electric field inside the chamber, and the induced electric field generates plasma by accelerating free electrons in the chamber to collide with a neighboring neutral gas. On the other hand, in a method of driving capacitively coupled plasma generators, two electrodes are installed in a chamber, and RF power is applied between the two electrodes to form an electric field that varies according to time in a space between the two electrodes. The formed electric field generates plasma by efficiently accelerating free electrons in the chamber to collide with a neighboring neutral gas.

In inductively coupled plasma generators, an antenna can be disposed outside a chamber, and an electric field induced by the antenna has a circular shape. Thus, in comparison with capacitively coupled plasma generators, free electrons can be accelerated regardless of the position of an electrode, and high density plasma can be ensured. Therefore, research on such inductively coupled plasma generators is attracting attention. For example, Korean Patent Registration No. 488363 discloses an antenna structure of an inductively coupled plasma generator in which at least two loop antennas are installed electrically in parallel, and Korean Patent Registration No. 800369 discloses an inductively coupled plasma antenna that includes at least two spiral segments wound around a cylindrical plasma generation unit and a switching unit respectively formed in the spiral segments and switching the power of a high-frequency power supply to the spiral segments.

### DISCLOSURE OF INVENTION

### Solution to Problem

In one embodiment, an antenna for inductively coupled plasma generation is provided. The antenna for inductively coupled plasma generation includes: a first end connected to an alternating current (AC) power supply; a second end connected to a ground terminal; and an antenna coil connected to the first end and the second end, and configured to receive power of the AC power supply and generate an induced electric field. The antenna coil includes one or more sub-coil units configured to generate a magnetic field in a region adjacent to the antenna coil unit in response to the power of the AC power supply.

In another embodiment, an inductively coupled plasma generator is provided. The inductively coupled plasma generator includes: a chamber; an AC power supply and a ground terminal which are disposed outside the chamber; and a loop antenna including a first end connected to the AC power supply, a second end connected to the ground terminal, and an antenna coil unit. The antenna coil unit includes one or more sub-coil units arranged along the antenna coil.

In yet another embodiment, a method of driving an inductively coupled plasma generator is provided. The method of driving an inductively coupled plasma generator includes a process of introducing a gas for forming plasma into a chamber, and also a process of supplying power of an AC power supply to one end of a coil of a loop antenna disposed on an outer wall of the chamber. The loop antenna includes one or more sub-coil units arranged along the loop antenna. The loop antenna generates an induced electric field in an inner region of the loop antenna in response to the power of the AC power supply. The one or more sub-coil units generate a magnetic field in a region adjacent to the loop antenna.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF DRAWINGS

The above and other features and advantages of the present disclosure will become more apparent to those of ordinary skill in the art by describing in detail example embodiments thereof with reference to the attached drawings in which:

FIG. 1 schematically illustrates an antenna for inductively coupled plasma generation according to an embodiment of the present disclosure;

FIG. 2 schematically illustrates an antenna for inductively coupled plasma generation according to another embodiment;

FIG. 3 schematically illustrates an antenna for inductively coupled plasma generation according to yet another embodiment;

FIG. 4 is a perspective view schematically illustrating arrangement of an antenna for inductively coupled plasma generation according to an embodiment;

FIG. 5 is a top view schematically illustrating arrangement of an antenna for inductively coupled plasma generation according to another embodiment;

FIG. 6 is a perspective view schematically illustrating arrangement of an antenna for inductively coupled plasma generation according to yet another embodiment;

FIG. 7 is a schematic view of an inductively coupled plasma generator according to an embodiment;

FIG. 8 is a schematic view of an inductively coupled plasma generator according to another embodiment;

FIG. 9 is a schematic view of an inductively coupled plasma generator according to yet another embodiment;

FIG. 10 is a cross-sectional view of an inductively coupled plasma generator according to still another embodiment;

FIG. 11 is a cross-sectional view of an inductively coupled plasma generator according to still another embodiment;

FIG. 12 is a schematic top view of an antenna for inductively coupled plasma generation according to still another embodiment;

FIG. 13 is a schematic top view of an antenna for inductively coupled plasma generation according to still another embodiment;

FIG. 14 illustrates a chamber constituted to measure plasma density according to an embodiment; and

FIG. 15 shows results of measuring density of plasma generated by various antennas according to an embodiment.

### MODE FOR THE INVENTION

It will be readily understood that the components of the present disclosure, as generally described and illustrated in the Figures herein, could be arranged and designed in a wide variety of different configurations. Thus, the following more detailed description of the embodiments of apparatus and methods in accordance with the present disclosure, as represented in the Figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout. Moreover, the drawings are not necessarily to scale, and the size and relative sizes of layers and regions may have been exaggerated for clarity.

It will also be understood that when an element or layer is referred to as being “on, another element or layer, the element or layer may be directly on the other element or layer or intervening elements or layers may be present.

As described above, conventional antennas for inductively coupled plasma generation generally include a spiral type coil or a separate electrode type coil, and it may be still difficult to control plasma formed in a chamber to have uniform distribution. To be specific, in an antenna having a spiral type coil, inductive coils constituting the antenna are connected in series, and an alternating current(AC) flowing through each of the inductive coils is controlled to have the same value. Accordingly, the AC induces a magnetic field that varies according to time and the magnetic field generates an induced electric field around the antenna. Although the AC is controlled to have the same value, it is difficult to control density distribution of plasma caused by the induced electric field in the chamber. That is, due to ion and electron loss on the inner wall of the chamber, plasma density may be high in the center of the chamber and low in a portion adjacent to the inner wall of the chamber. Furthermore, since the inductive coils of the antenna are connected in series, voltage drop due to the antenna is great, which increases the influence of capacitive coupling between plasma and the inductive coils. Thus, power efficiency decreases, and it may be difficult to keep uniformity in the density distribution of plasma in the entire inner space of the chamber.

In an antenna having a separate electrode type coil, an antenna coil of the antenna may have, for example, three separate electrodes respectively connected to three high-frequency power supplies of different phases, At this time, plasma density generated by the antenna is high at a position adjacent to the respective separate electrodes but decreases from the respective separate electrodes to the center of the chamber. Thus, it may be difficult to ensure the uniformity in the density distribution of plasma.

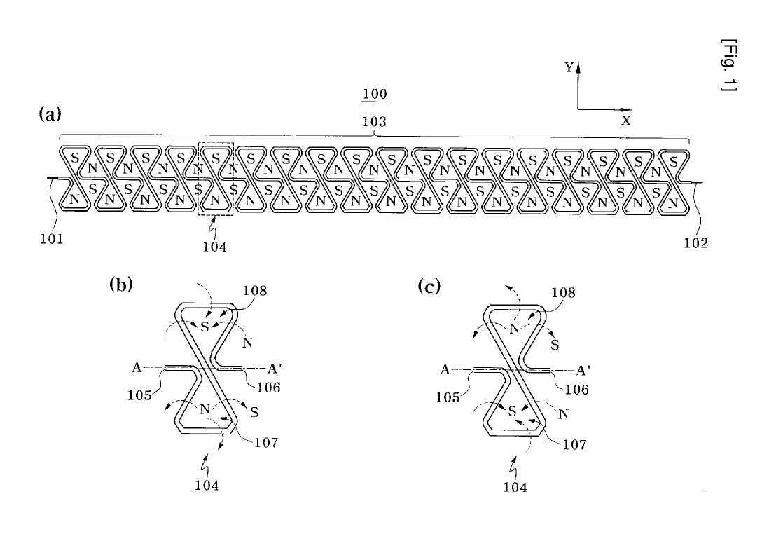

FIG. 1 schematically illustrates an antenna for inductively coupled plasma generation according to an embodiment of the present disclosure. Part (a) Of FIG. 1 shows a top view of an antenna for inductively coupled plasma generation according to an embodiment, and Parts (b) and (c) of FIG. 1 show top views of a sub-coil unit of the antenna for inductively coupled plasma generation according to an embodiment.

Referring to part (a) of FIG. 1, an antenna 100 for inductively coupled plasma generation includes a first end 101, a second end 102, and an antenna coil unit 103. The first end 101 may be connected to an AC power supply (not shown) such as a high frequency power supply or a radio frequency (RF) power supply, and the second end 102 may be connected to a ground terminal (not shown). Alternatively, the first end 101 may be connected to the ground terminal, and the second end 102 may be connected to the AC power supply.

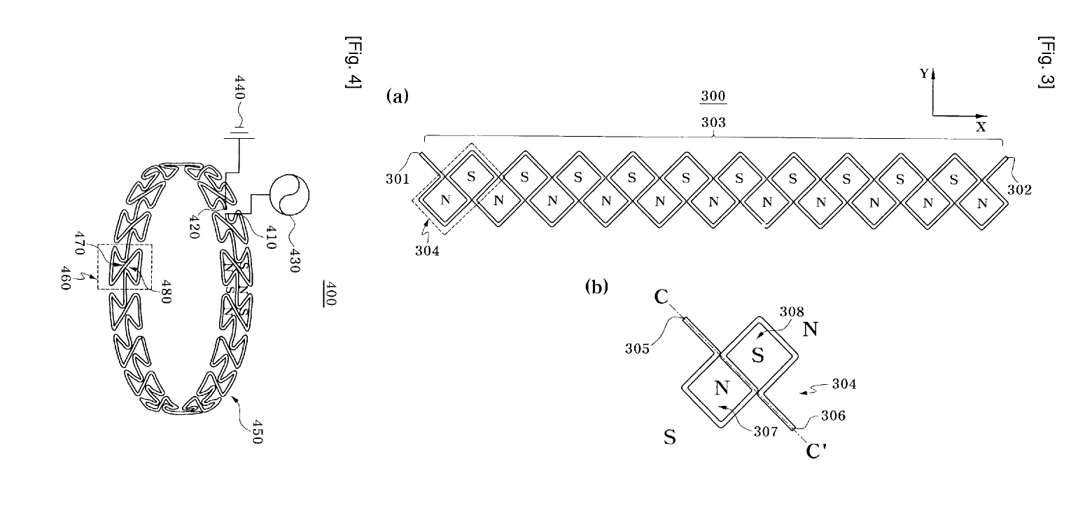

The antenna coil unit 103 is connected to the first end 101 and the second end 102, receives the power of the AC power supply, and generates an induced electric field. According to Ampere s law, a magnetic field is formed around the antenna coil unit 103 when current is applied to the antenna coil unit 103. When power from the AC power supply is applied, a magnetic field varying according to time is generated around the antenna coil unit 103, and an induced electromotive force is generated around the antenna coil unit 103 according to Faraday s law of electromagnetic induction. The induced electromagnetic force forms an induced electric field around the antenna coil unit 103 in the opposite direction to the power applied from the AC power supply. According to an embodiment, the antenna 100 for inductively coupled plasma generation may be disposed to have the form of a loop as shown in FIGS. 4 to 6. In this case, the antenna 100 may receive the power applied from the AC power supply and form an induced electric field having a circular shape through the loop.

The antenna coil unit 103 includes one or more sub-coil units 104. The sub-coil units 104 may be formed in one body with the antenna coil unit 103 by shaping an antenna coil along the longitudinal direction (i.e., the X-axis direction in part (a) of FIG. 1). For example, the sub-coil units 104 may be arranged in the same shape as each other along the longitudinal direction of the antenna coil unit 103.

Parts (b) and (c) of FIG. 1 show one of the sub-coil units 104 according to an embodiment. As shown in the drawings, the sub-coil unit 104 may have a substantially symmetrical shape with respect to line A-A′. For example, in the sub-coil unit 104, a lower triangle coil 107 and an upper triangle coil 108 may be symmetric to each other with respect to line A-A′.

Referring to part (b) of FIG. 1, when current that flows from a left end 105 to a right end 106 is supplied from the AC power supply to the sub-coil unit 104, a magnetic field may be formed around the sub-coil unit 104 according to Ampere s law. In this case, the direction of lines of magnetic force may be different according to a portion of the sub-coil unit 104 such as the lower triangle coil 107 or the upper triangle coil 108. From the lower triangle coil 107, a line of magnetic force may be generated to have a direction that is from the inside of the lower triangle coil 107 to the outside of the lower triangle coil 107. On the other hand, from the upper triangle coil 108, a line of magnetic force may be generated to have a direction that is from the outside of the upper triangle coil 108 to the inside of the upper triangle coil 108. In this specification, the magnetic field polarity of a part in which a line of magnetic force is emitted is indicated by N pole, and the magnetic field polarity of a part in which a line of magnetic force is gathered is indicated by S pole. As shown in part (b) of FIG. 1, when current flows from the left end 105 to the right end 106, a magnetic field may be locally formed to have the polarity of the N pole inside the lower triangle coil 107 and the polarity of the S pole outside the lower triangle coil 107. Also, a magnetic field may be locally formed to have the polarity of the S pole inside the upper triangle coil 108 and the polarity of the N pole outside the upper triangle coil 108. Thus, a magnetic field in the sub-coil unit 104 may be formed to have the polarity of the N pole inside the lower triangle coil 107 and the polarity of the S pole inside the upper triangle coil 108.

Referring to part (c) of FIG. 1, when current that flows from the right end 106 to the left end 105 is supplied from the AC power supply to the sub-coil unit 104, a magnetic field may be likewise formed around the sub-coil unit 104 according to Ampere s law. As shown in part (c) of FIG. 1, a magnetic field having the polarity of the S pole inside the lower triangle coil 107 and the polarity of the N pole outside the lower triangle coil 107 may be locally formed. Also, a magnetic field having the polarity of the N pole inside the upper triangle coil 108 and the polarity of the S pole outside the upper triangle coil 108 may be locally formed. Thus, a magnetic field in the sub-coil unit 104 may be formed to have the polarity of the N pole inside the upper triangle coil 108 and the polarity of the S pole inside the lower triangle coil 107.

Referring back to part (a) of FIG. 1, when power is applied from the AC power supply to the antenna 100 for inductively coupled plasma generation, an induced electric field is generated around the antenna coil unit 103, and also a new magnetic field caused by the sub-coil units 104 may be locally formed in a region adjacent to the sub-coil units 104. According to an embodiment, because the direction of current supplied from the AC power supply to the antenna 100 varies according to time, a magnetic field having lines of magnetic force shown in part (b) of FIG. 1 and a magnetic field having lines of magnetic force shown in part (c) of FIG. 1 may be alternated according to time.

As shown in part (a) of FIG. 1, the N pole and S pole of the sub-coil units 104 are arranged in turn along the longitudinal direction of the antenna coil unit 103 (i.e., the X-axis direction) with respect to power applied from the outside, and the sub-coil units 104 may be disposed to form a local magnetic field whose polarity varies according to time. Also, the sub-coil units 104 may be disposed to form a magnetic field whose N pole and S pole are symmetrically arranged in a direction (i.e., the Y-axis direction of part (a) of FIG. 1) substantially perpendicular to the longitudinal direction of the antenna coil unit 103 with respect to line A-A′. According to an embodiment, the sub-coil units 104 may be manufactured that the N pole and S pole of the sub-coil units 104 have lines of magnetic force of substantially the same magnitude with each other.

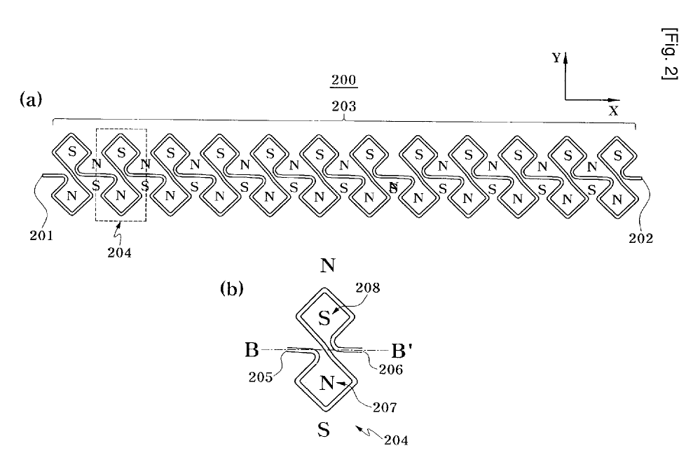

FIG. 2 schematically illustrates an antenna for inductively coupled plasma generation according to another embodiment. Part (a) of FIG. 2 shows a top view of an antenna for inductively coupled plasma generation according to another embodiment, and part (b) of FIG. 2 shows a top view of sub-coil units of the antenna for inductively coupled plasma generation shown in part (a) of FIG. 2.

Referring to part (a) of FIG. 2, an antenna 200 for inductively coupled plasma generation includes a first end 201, a second end 202, and an antenna coil unit 203. The antenna coil unit 203 includes one or more sub-coil units 204. The sub-coil units 204 may be formed in one body with the antenna coil unit 203 by shaping an antenna coil along the longitudinal direction (i.e., the X-axis direction).

Referring to part (b) of FIG. 2, the sub-coil units 204 may have a substantially symmetrical shape with respect to line B-B′. For example, in the sub-coil units 204, a lower diamond-shaped coil 207 and an upper diamond-shaped coil 208 may be symmetric to each other with respect to line B-B′. As described with reference to parts (a) to (c) of FIG. 1, when current flows from a left end 205 to a right end 206, a magnetic field may be locally formed to have the polarity of the N pole inside the lower diamond-shaped coil 207 and the polarity of the S pole outside the lower diamond-shaped coil 207. Also, a magnetic field may be locally formed to have the polarity of the S pole inside the upper diamond-shaped coil 208 and the polarity of the N pole outside the upper diamond-shaped coil 208. Thus, a magnetic field in the sub-coil units 204 may be formed to have the polarity of the N pole inside the lower diamond-shaped coil 207 and the polarity of the S pole inside the upper diamond-shaped coil 208.

Although not shown in the drawings, when current flows from the right end 206 to the left end 205, a magnetic field having polarities opposite to those of the case where the current flows from the left end 205 to the right end 206 may be locally formed in a region adjacent to the sub-coil units 204.

According to other embodiments, the sub-coil units 204 may have any structure satisfying the requirement of a substantially symmetrical shape with respect to line B-B′. For example, the structure may include polygonal and circular upper and lower coils symmetric to each other.

According to an embodiment, the antenna 200 for inductively coupled plasma generation may be disposed to have the form of a loop as shown in FIGS. 4 to 6. In this case, the antenna 200 may receive the power applied from the AC power supply and form an induced electric field having a circular shape through the loop.

FIG. 3 schematically illustrates an antenna for inductively coupled plasma generation according to yet another embodiment. Part (a) of FIG. 3 shows a top view of an antenna for inductively coupled plasma generation according to yet another embodiment, and part (b) of FIG. 3 shows a top view of a sub-coil unit of the antenna for inductively coupled plasma generation according to yet another embodiment.

Referring to part (a) of FIG. 3, an antenna 300 for inductively coupled plasma generation includes a first end 301, a second end 302, and an antenna coil unit 303. The antenna coil unit 303 includes one or more sub-coil units 304. The sub-coil units 304 may be formed in one body with the antenna coil unit 303 by shaping an antenna coil along the longitudinal direction (i.e., the X-axis direction of part (a) of FIG. 3).

Referring to part (b) of FIG. 3, the sub-coil units 304 may have a substantially symmetrical shape with respect to a direction forming a predetermined angle, e.g., 0 to 180, with respect to the X-axis direction. For example, in the sub-coil units 304, a lower diamond-shaped coil 307 and an upper diamond-shaped coil 308 may be symmetric to each other with respect to line C-C′. When current flows from a left end 305 to a right end 306, a magnetic field may be locally formed to have the polarity of the N pole inside the lower diamond-shaped coil 307 and the polarity of the S pole outside the lower diamond-shaped coil 307. Also, a magnetic field may be locally formed to have the polarity of the S pole inside the upper diamond-shaped coil 308 and the polarity of the N pole outside the upper diamond-shaped coil 308. Thus, a magnetic field in the sub-coil units 304 may be formed to have the polarity of the N pole inside the lower diamond-shaped coil 307 and the polarity of the S pole inside the upper diamond-shaped coil 308. Although not shown in the drawings, when current flows from the right end 306 to the left end 305, a magnetic field having polarities opposite to those of the case where the current flows from the left end 305 to the right end 306 may be locally formed in a region adjacent to the sub-coil units 304.

According to other embodiments, the sub-coil units 304 may have any structure satisfying the requirement of a substantially symmetrical shape with respect to line C-C′ forming a predetermined angle, e.g., 0 to 180, with respect to the X-axis. For example, the structure may include polygonal and circular upper and lower coils symmetric to each other.

According to an embodiment, the antenna 300 for inductively coupled plasma generation may be disposed to have the form of a loop as shown in FIGS. 4 to 6. In this case, the antenna 300 may receive the power applied from the AC power supply and form an induced electric field having a circular shape through the loop.

FIG. 4 is a perspective view schematically illustrating arrangement of an antenna for inductively coupled plasma generation according to an embodiment. Referring to FIG. 4, an antenna 400 for inductively coupled plasma generation includes a first end 410, a second end 420, and an antenna coil unit 450. The antenna coil unit 450 includes one or more sub-coil units 460. The sub-coil units 460 may be formed in one of the shapes of the sub-coil units 104, 204 and 304 of the embodiments described with reference to FIGS. 1 to 3.

As shown in the drawing, the antenna coil unit 450 is arranged in the form of a loop, the first end 410 is connected to an AC power supply 430, and a second end 420 is connected to a ground terminal 440. The AC power supply 430 may be, for example, a high frequency power supply or a radio frequency (RF) power supply. As one example, the RF power supply may provide frequencies of 2 MHz to 2.45 GHz for the antenna coil unit 450. As another example, the RF power supply may provide frequency of 13.56 MHz for the antenna coil unit 450. Planes constituted by lower coils 470 and upper coils 480 of the sub-coil units 460 may be different from a bottom plane on which the antenna coil unit 450 in the form of the loop is disposed. For example, the planes constituted by the lower coils 470 and upper coils 480 may be substantially perpendicular to the bottom plane on which the antenna coil unit 450 in the form of the loop is disposed. In this specification, an antenna having substantially the same shape as that of the antenna 400 is referred to as a vertical antenna. In the vertical antenna, planes where sub-coil units constitute are substantially perpendicular to a bottom plane where an antenna coil unit in the form of a loop is disposed. According to some embodiments, the vertical antenna may be arranged to have one or more loop turns. Also, the vertical antenna may be arranged to surround the outer wall of a chamber.

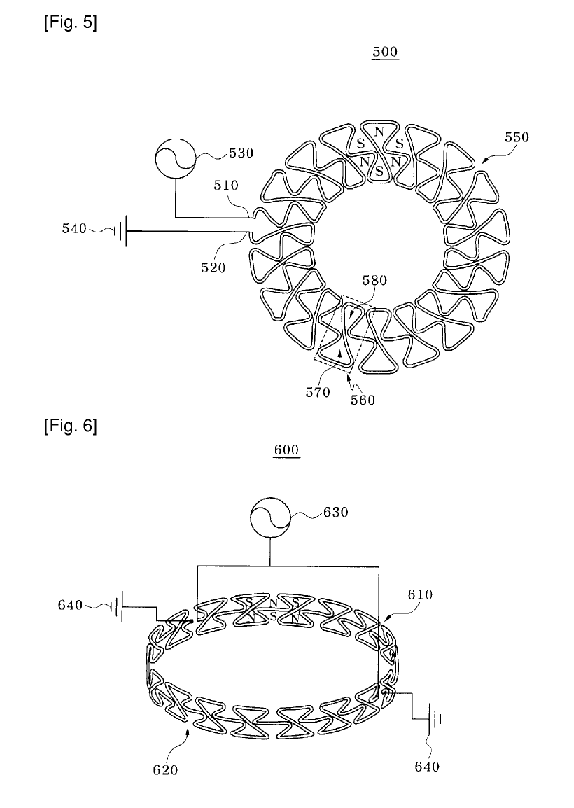

FIG. 5 is a top view schematically illustrating arrangement of an antenna for inductively coupled plasma generation according to another embodiment. Referring to FIG. 5, an antenna 500 for inductively coupled plasma generation includes a first end 510, a second end 520, and an antenna coil unit 550. The antenna coil unit 550 includes one or more sub-coil units 560. The sub-coil units 560 may be formed in one of the shapes of the sub-coil units 104, 204 and 304 of the embodiments described with reference to FIGS. 1 to 3.

As shown in the drawing, the antenna coil unit 550 is arranged in the form of a loop, the first end 510 is connected to an AC power supply 530, and a second end 520 is connected to a ground terminal 540. The AC power supply 530 may be, for example, a high frequency power supply or a radio frequency (RF) power supply. As one example, the RF power supply may provide frequencies of 2 MHz to 2.45 GHz for the antenna coil unit 550. As another example, the RF power supply may provide frequency of 13.56 MHz for the antenna coil unit 550. Planes constituted by lower coils 570 and upper coils 580 of the sub-coil units 560 may be substantially the same as a bottom plane on which the antenna coil unit 550 in the form of the loop is disposed. In this specification, an antenna having substantially the same shape as that of the antenna 500 is referred to as a horizontal antenna. In the horizontal antenna, planes where sub-coil units constitute are substantially the same as a bottom plane where an antenna coil unit in the form of a loop is disposed. According to some embodiments, the horizontal antenna may be arranged to have one or more loop turns. Also, the horizontal antenna may be arranged on the outer wall of a chamber.

FIG. 6 is a perspective view schematically illustrating arrangement of an antenna for inductively coupled plasma generation according to yet another embodiment. Referring to FIG. 6, an antenna 600 for inductively coupled plasma generation includes a first segment 610 and a second segment 620 that are physically separated from each other, and is arranged in the form of a loop. The first segment 610 and the second segment 620 are substantially the same as the antennas 100, 200 and 300 for inductively coupled plasma generation of the embodiments described with reference to FIGS. 1 to 3.

The first segment 610 and the second segment 620 may be vertical antennas, and connected to an AC power supply 630 and a ground terminal 640 in parallel. Alternatively, each of the first segment 610 and the second segment 620 may be a horizontal antenna, or a combination of the vertical antenna and the horizontal antenna. According to other embodiments, the antenna 600 for inductively coupled plasma generation may include three or more segments. The AC power supply 630 may be, for example, a high frequency power supply or a radio frequency (RF) power supply. As one example, the RF power supply may provide frequencies of 2 MHz to 2.45 GHz for the first segment 610 and the second segment 620. As another example, the RF power supply may provide frequency of 13.56 MHz for the first segment 610 and the second segment 620.

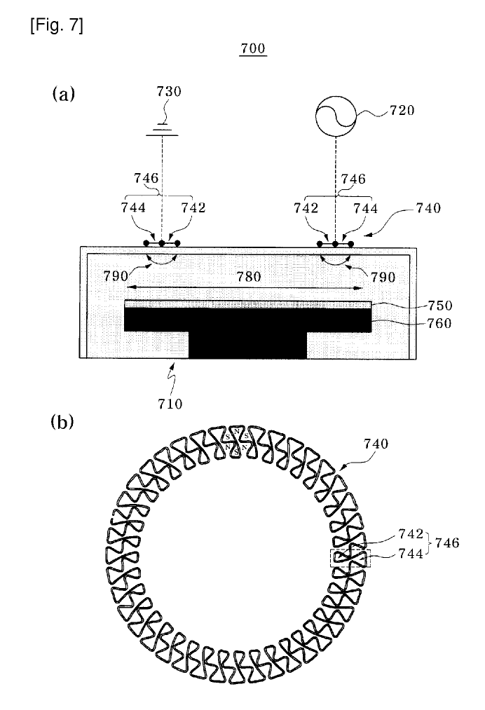

FIG. 7 is a schematic view of an inductively coupled plasma generator according to an embodiment. Part (a) of FIG. 7 shows a cross-sectional view of an inductively coupled plasma generator according to an embodiment, and part (b) of FIG. 7 shows a top view of a loop antenna shown in part (a) of FIG. 7. Referring to parts (a) and (b) of FIG. 7, an inductively coupled plasma generator 700 includes a chamber 710, an AC power supply 720, a ground terminal 730, and a loop antenna 740.

The chamber 710 may include a wafer 750 and a chuck 760 that supports the wafer 750. Although not shown in the drawing, the chamber 710 may further include a gas inlet for supplying a gas for plasma generation and reaction, a gas outlet and pump system for discharging a gas in the chamber 710.

The AC power supply 720 and the ground terminal 730 may be disposed outside the chamber 710 and supply the loop antenna 740 with power for inductively coupled plasma generation. The AC power supply 720 may be, for example, a high frequency power supply or a radio frequency (RF) power supply. As one example, the RF power supply may provide frequencies of 2 MHz to 2.45 GHz for the loop antenna 740. As another example, the RF power supply may provide frequency of 13.56 MHz for the loop antenna 740.

The antennas 100, 200 and 300 for inductively coupled plasma generation described with reference to FIGS. 1 to 3 can be applied to the loop antenna 740. Referring to FIG. 7, the loop antenna 740 is disposed on a flat surface of the outer wall of the chamber and connected to the AC power supply 720 and the ground terminal 730. The loop antenna 740 has one or more sub-coil units 746 including an upper coil 742 and a lower coil 744, and is arranged as a horizontal antenna described with reference to FIG. 5.

A gas, e.g., a non-reactive gas such as helium, hydrogen, argon or nitrogen, for plasma generation is introduced into the chamber 710, and a pressure in the chamber 710 can be kept constant using the pump system. And, the AC power supply 720 disposed outside the chamber 710 supplies power to one end of the loop antenna 740.

When power varying according to time is supplied from the AC power supply 720, a magnetic field having magnetic flux that varies according to time is formed in the loop of the loop antenna 740 according to Ampere s law. The magnetic field having the magnetic flux varying according to time generates an induced electric field in the loop inside the chamber 710 according to Faraday s law. Free electrons accelerated along the induced electric field collide with a neutral gas and ionize the neutral gas, thereby generating plasma. At this time, the ions and electrons accelerated by the induced electric field collide with the inner wall of the chamber 710 and are lost, so that plasma density may be higher in the center of the chamber 710 and lower in a portion adjacent to the inner wall of the chamber 710. In this embodiment, the antenna coil of the loop antenna 740 includes the one or more sub-coil units 746, thus generating a local magnetic field around the antenna coil separately from the induced electric field. The magnetic field locally formed around the antenna coil applies Lorentz force to electrons or ions having a charge, thereby preventing the electrons or ions from approaching the inner wall of the chamber 710 and capturing and confining the electrons or ions in a predetermined region near the inner wall of the chamber 710. Thus, a sheath region in which no electrons exist between plasma and the inner wall of the chamber 710 may be reduced around a region in which the sub-coil units 746 exist. The captured and confined electrons or ions near the inner wall of the chamber 710 can increase the ionization rate of the gas. As a result, plasma density around the inner wall of the chamber 710 on which the sub-coil units 746 are disposed can increase. Also, the local magnetic field effectively prevents collision between ions in plasma and the inner wall of the chamber 710, so that generation of particles that pollute the chamber 710 can be inhibited.

As shown in FIG. 7, when the loop antenna 740 is disposed on the flat surface of the outer wall of the chamber 710 and is supplied with power varying according to time from the AC power supply 720, a magnetic field varying according to time is generated in a direction penetrating the loop of the loop antenna 740 in the chamber 710. In succession, the magnetic field varying according to time generates an induced electric field 780 having a direction opposite to that of the power supplied from the AC power supply 720 according to Faraday s law. Also, a local magnetic field 790 may be generated around the loop antenna 740 by the sub-coil units 746. The local magnetic field 790 may serve to increase plasma density near the inner wall of the chamber 710.

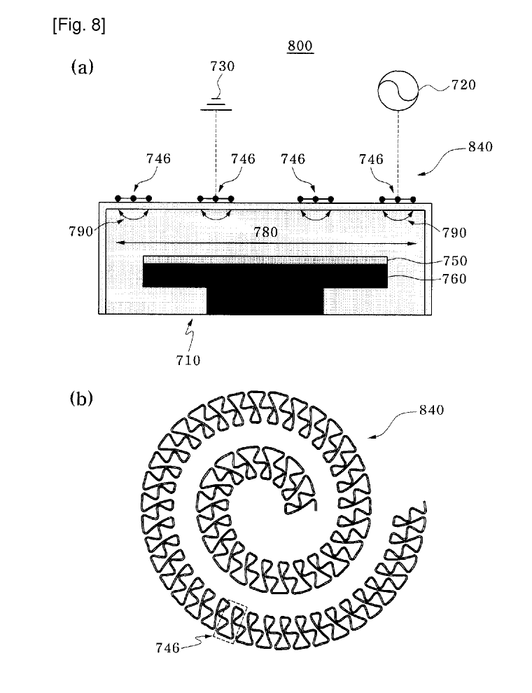

FIG. 8 is a schematic view of an inductively coupled plasma generator according to another embodiment. Part (a) of FIG. 8 shows a cross-sectional view of an inductively coupled plasma generator according to another embodiment, and part (b) of FIG. 8 shows a top view of a loop antenna shown in part (a) of FIG. 8. Referring to parts (a) and (b) of FIG. 8, an inductively coupled plasma generator 800 includes a chamber 710, an AC power supply 720, a ground terminal 730, and a loop antenna 840. Components denoted by the same reference numerals as in the embodiment described with reference to FIG. 7 will not be described again in detail.

The loop antenna 840 is substantially the same as the loop antenna 740 described with reference to FIG. 7 except that the loop antenna 840 is in the form of a spiral loop having a plurality of turns. As a result, when the loop antenna 840 is in the form of a spiral loop having a plurality of turns, the loop antenna 840 can effectively reduce a sheath region on the inner wall of the chamber 710 adjacent to the loop antenna 840 and effectively increase plasma density that is lower than that of the center of the chamber 710.

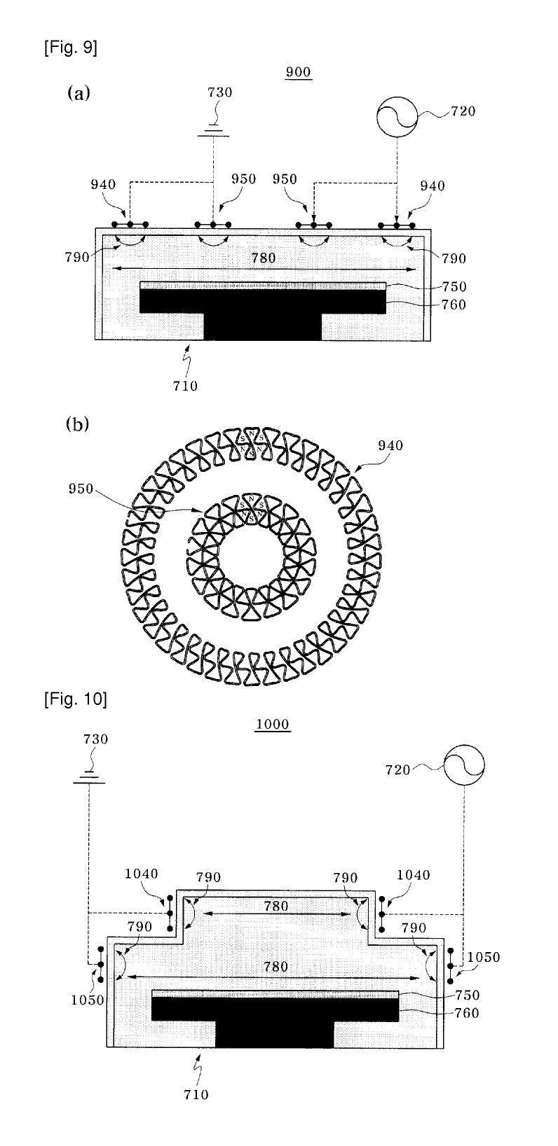

FIG. 9 is a schematic view of an inductively coupled plasma generator according to yet another embodiment. Part (a) of FIG. 9 shows a cross-sectional view of an inductively coupled plasma generator according to yet another embodiment, and part (b) of FIG. 9 shows a top view of loop antennas shown in part (a) of FIG. 9. Referring to parts (a) and (b) of FIG. 9, an inductively coupled plasma generator 900 includes a chamber 710, an AC power supply 720, a ground terminal 730, and loop antennas 940 and 950. Components denoted by the same reference numerals as in the embodiment described with reference to FIG. 7 will not be described again in detail.

The loop antennas 940 and 950 are substantially the same as the loop antenna 740 described with reference to FIG. 7 except that the loop antennas 940 and 950 are physically separated from each other. The loop antennas 940 and 950 are connected to the AC power supply 720 and the ground terminal 730 in parallel. Alternatively, the loop antennas 940 and 950 may be connected to the AC power supply 720 and the ground terminal 730 in series. Referring to the drawings, the loop antenna 940 forms an outer loop, and the loop antenna 950 forms an inner loop. In some embodiments, three or more physically separated loop antennas may exist, and each of the loop antennas may be connected to the AC power supply 720 and the ground terminal 730.

In this embodiment, a plurality of physically separated loop antennas can be disposed on a flat surface of the outer wall of a chamber, and can effectively reduce a sheath region on the inner wall of the chamber 710 adjacent to the loop antennas 940 and 950 and effectively increase plasma density that is lower than that of the center of the chamber 710.

FIG. 10 is a cross-sectional view of an inductively coupled plasma generator according to still another embodiment. Referring to FIG. 10, an inductively coupled plasma generator 1000 includes a chamber 710, an AC power supply 720, a ground terminal 730, and loop antennas 1040 and 1050. Components denoted by the same reference numerals as in the embodiment described with reference to FIG. 7 will not be described again in detail.

Each of the loop antennas 1040 and 1050 may be arranged in substantially the same way as in the embodiment described with reference to FIG. 4 or 6. Each of the loop antennas 1040 and 1050 may be the vertical antenna arranged to surround a curved surface of the outer wall of the chamber 710. The vertical antenna operates in the same way as the horizontal antenna described with reference to FIGS. 7 to 9, and can form a local magnetic field 790 in a region adjacent to the vertical antenna while forming an induced electric field 780 inside the chamber 710.

As shown in the drawing, the loop antennas 1040 and 1050 are connected to the AC power supply 720 and the ground terminal 730 in parallel. Alternatively, the loop antennas 1040 and 1050 may be connected to the AC power supply 720 and the ground terminal 730 in series.

As a result, the loop antennas 1040 and 1050 can effectively reduce a sheath region on the inner wall of the chamber 710 adjacent to the loop antennas 1040 and 1050 and effectively increase plasma density that is lower than that of the center of the chamber 710.

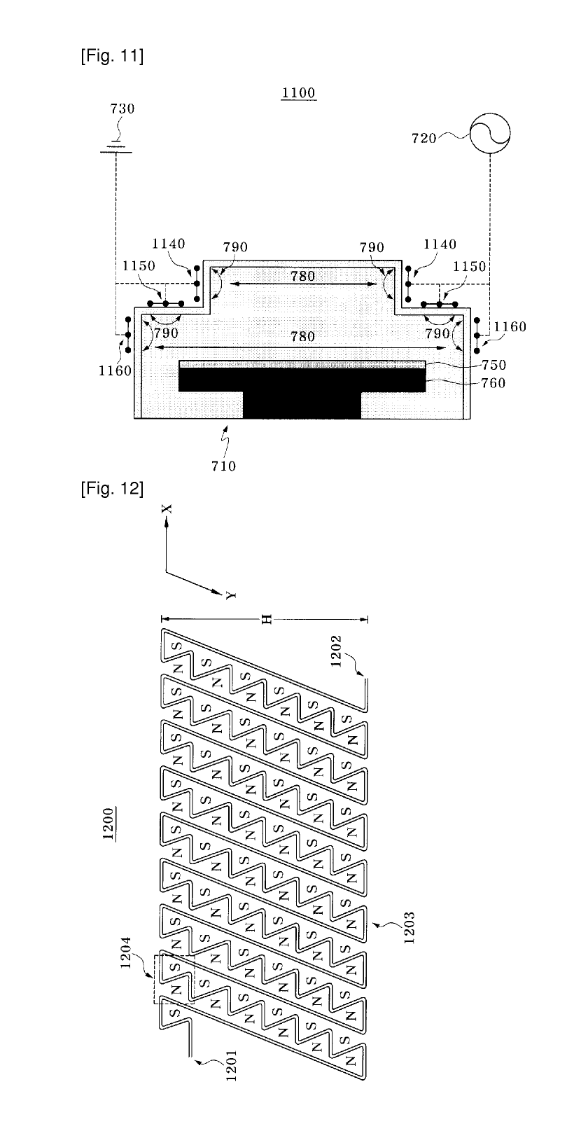

FIG. 11 is a cross-sectional view of an inductively coupled plasma generator according to still another embodiment. Referring to FIG. 11, an inductively coupled plasma generator 1100 includes a chamber 710, an AC power supply 720, a ground terminal 730, and loop antennas 1140, 1150 and 1160. Components denoted by the same reference numerals as in the embodiment described with reference to FIG. 7 will not be described again in detail.

The loop antennas 1140 and 1160 may be arranged in substantially the same way as in the embodiment described with reference to FIG. 10. The loop antenna 1150 may be arranged in substantially the same way as in the embodiment described with reference to FIG. 7. Each of the loop antennas 1140 and 1160 is arranged to surround a curved surface of the outer wall of the chamber 710, and the loop antenna 1150 is arranged on a flat surface of the outer wall of the chamber 710.

As a result, the loop antennas 1140, 1150 and 1160 can effectively reduce a sheath region on the inner wall of the chamber 710 adjacent to the loop antennas 1140, 1150 and 1160 and effectively increase plasma density that is lower than that of the center of the chamber 710.

FIG. 12 is a schematic top view of an antenna for inductively coupled plasma generation according to still another embodiment. Referring to FIG. 12, an antenna 1200 for inductively coupled plasma generation includes a first end 1201, a second end 1202, and an antenna coil unit 1203. The antenna coil unit 1203 ,may be formed by shaping an antenna coil along X- and Y-axis directions. The antenna coil unit 1203 includes one or more sub-coil units 1204 arranged along the X- and Y-axis directions. When power is applied to the first end 1201 and the second end 1202, the antenna coil unit 1203 forms an induced electric field in response to the power applied from the outside in substantially the same way as the antenna coil units 103, 203 and 303 described with reference to FIGS. 1 to 3. The sub-coil units 1204 form a local magnetic field around the sub-coil units 1204 themselves in substantially the same way as the sub-coil units 104, 204 and 304 described with reference to FIGS. 1 to 3. The antenna 1200 for inductively coupled plasma generation may be arranged in the form of a loop to surround a curved surface of the outer wall of a chamber in a similar way to the antenna 400 for inductively coupled plasma generation of the embodiment described with reference to FIG. 4.

According to an embodiment, a height H of the antenna 1200 for inductively coupled plasma generation may be adjusted on the basis of the height of the outer wall of the chamber. For example, the height H of the antenna 1200 for inductively coupled plasma generation may be substantially the same as the height of the outer wall of the chamber. Thus, the antenna 1200 for inductively coupled plasma generation can surround most of the outer wall of the chamber.

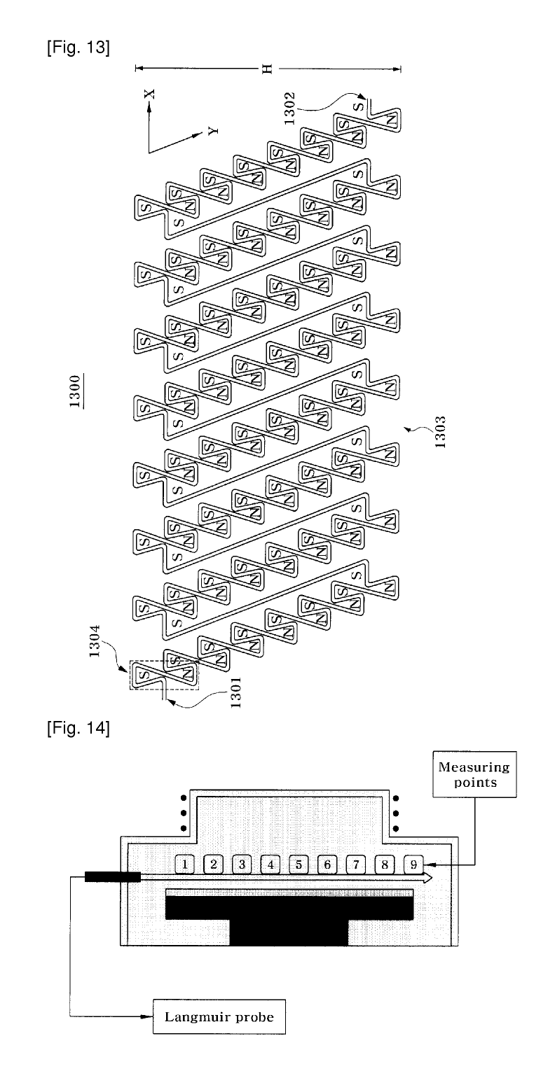

FIG. 13 is a schematic top view of an antenna for inductively coupled plasma generation according to still another embodiment. Referring to FIG. 13, an antenna 1300 for inductively coupled plasma generation includes a first end 1301, a second end 1302, and an antenna coil unit 1303. The antenna coil unit 1303 includes one or more sub-coil units 1304 arranged along X- and Y-axis directions. The antenna coil unit 1303 is arranged in a similar way to the antenna coil unit 1203 of FIG. 12 except for the shape of the sub-coil units 1304.

When power is applied to the first end 1301 and the second end 1302, the antenna coil unit 1303 forms an induced electric field in response to the power applied from the outside in substantially the same way as the antenna coil units 103, 203 and 303 described with reference to FIGS. 1 to 3. The sub-coil units 1304 form a local magnetic field around the sub-coil units 1304 themselves in substantially the same way as the sub-coil units 104, 204 and 304 described with reference to FIGS. 1 to 3. The antenna 1300 for inductively coupled plasma generation may be arranged in the form of a loop to surround a curved surface of the outer wall of a chamber in a similar way to the antenna 400 for inductively coupled plasma generation of the embodiment described with reference to FIG. 4. According to this embodiment, a height H of the antenna 1300 for inductively coupled plasma generation can be adjusted in proportion to the height of the outer wall of the chamber, and the antenna 1300 for inductively coupled plasma generation can surround most of the outer wall of the chamber.

Thus far, embodiments of some aspects of the present disclosure have been described. However, the scope of the present disclosure is not limited to the above-described embodiments and, needless to say, includes various modifications that those skilled in the art can infer. To be specific, in some embodiments, arrangement of the loop antennas can be diversified according to the form of a chamber.

Hereinafter, a constitution and effect of the present disclosure will be described in detail with reference to detailed embodiments and comparative embodiments. However, the embodiments are not intended to limit the scope of the disclosure, but merely to aid in understanding of the disclosure.

### Embodiment

A parallel double spiral antenna obtained by combining two single coils each having two turns, a single coil antenna having two turns, and a vertical antenna having one turn were arranged to surround the outer wall of a cylindrical chamber, and plasma density and distribution were observed. The vertical antenna is substantially the same as the antenna 400 for inductively coupled plasma generation shown in FIG. 4, and surrounds the outer wall of the cylindrical chamber.

Argon gas was introduced into the chamber at 400 sccm, and the chamber was maintained at a pressure of 800 mTorr. A wafer was disposed inside the chamber, and plasma density was measured at predetermined intervals from one end on the wafer to the other end using Langmuir probe to observe distribution of plasma density in the chamber.

FIG. 14 illustrates a chamber constituted to measure plasma density according to an embodiment of the present disclosure. As shown in the drawing, plasma density was measured at nine points on a wafer while power supplied to each antenna was changed.

### <Evaluation>

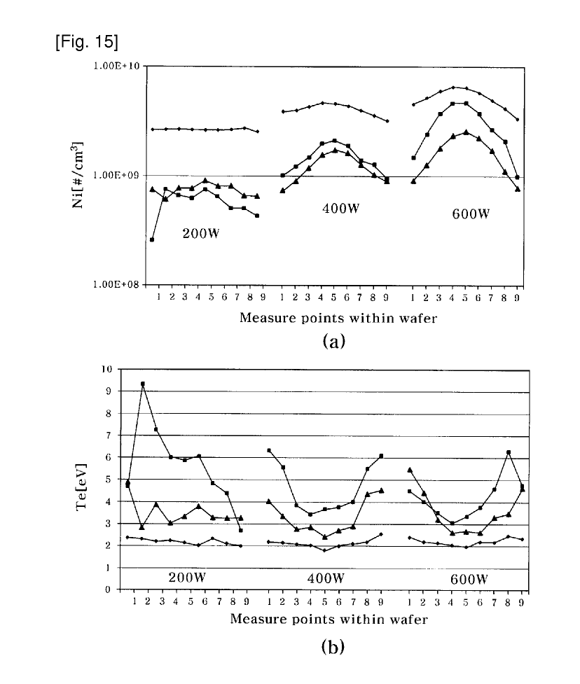

FIG. 15 shows results of measuring density of plasma generated by various antennas according to an embodiment. Part (a) of FIG. 15 shows density of plasma generated by various antennas according to supplied power and position on the wafer. Triangular indicators denote experimental results of the parallel double spiral antenna, square indicators denote results of the single coil antenna, and the diamond-shaped indicators denote results of the vertical antenna. Part (b) of FIG. 15 shows temperature of electrons in plasma generated by the various antennas according to supplied power and position on the wafer.

Referring to part (a) of FIG. 15, density of plasma generated by the vertical antenna is higher than that generated by the other two antennas in all the cases of 200 W, 400 W and 600 W. Also, plasma distribution of the vertical antenna has a small deviation and is uniform between the center and outer portions of the wafer in comparison with the other two antennas.

Referring to part (b) of FIG. 15, electron temperature in plasma generated by the vertical antenna disclosed in this specification is lower than that in plasma generated by the other two antennas and is stable. Also, electron temperature in plasma generated by the vertical antenna has a small deviation and is uniform between the center and outer portion of the wafer.

Consequently, it can be seen that plasma generated by the vertical antenna has relatively high density and is uniformly distributed between the center and inner wall of a chamber.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

1. An antenna for inductively coupled plasma generation, comprising:
a first end connected to an alternating current (AC) power supply;
a second end connected to a ground terminal; and
an antenna coil unit connected to the first end and the second end, and configured to receive power of the AC power supply and generate an induced electric field,
wherein the antenna coil unit comprises one or more sub-coil units configured to generate a magnetic field in a region adjacent to the antenna coil unit in response to the power of the AC power supply.

2. The antenna of claim 1, wherein the one or more sub-coil units are formed in one body with the antenna coil unit by shaping an antenna coil along a longitudinal direction.

3. The antenna of claim 2, wherein the one or more sub-coil units are arranged in substantially the same shape as each other along the longitudinal direction of the antenna coil unit.

4. The antenna of claim 1, wherein the one or more sub-coil units are disposed to generate magnetic fields whose N poles and S poles are alternately arranged in a longitudinal direction of the antenna coil unit.

5. The antenna of claim 1, wherein the one or more sub-coil units generate magnetic fields whose N poles and S poles are symmetrically arranged in a direction substantially perpendicular to a longitudinal direction of the antenna coil unit.

6. The antenna of claim 4, wherein the one or more sub-coil units are configured so that the N pole and the S pole have lines of magnetic force of substantially the same magnitude.

7. The antenna of claim 1, wherein the antenna coil unit is a loop coil having a plurality of turns.

8. The antenna of claim 1, wherein the antenna coil unit has a loop shape, and forms the induced electric field in the loop in response to the power of the AC power supply.

9. An inductively coupled plasma generator, comprising:
a chamber;
an alternating current (AC) power supply and a ground terminal which are disposed outside the chamber; and
a loop antenna including a first end connected to the AC power supply, a second end connected to the ground terminal, and an antenna coil unit,
wherein the antenna coil unit comprises one or more sub-coil units arranged along the antenna coil unit.

10. The inductively coupled plasma generator of claim 9, wherein the one or more sub-coil units are formed in one body with the antenna coil unit by shaping an antenna coil.

11. The inductively coupled plasma generator of claim 9, wherein the one or more sub-coil units are disposed to generate local magnetic fields whose N poles and S poles are alternately arranged along a longitudinal direction of the antenna coil unit.

12. The inductively coupled plasma generator of claim 9, wherein the one or more sub-coil units generate local magnetic fields whose N poles and S poles are symmetrically arranged in a direction substantially perpendicular to a longitudinal direction of the antenna coil unit.

13. The inductively coupled plasma generator of claim 11, wherein the one or more sub-coil units are configured so that the N poles and the S poles have lines of magnetic force of substantially the same magnitude.

14. The inductively coupled plasma generator of claim 9, wherein the loop antenna comprises the antenna coil unit having a plurality of turns.

15. The inductively coupled plasma generator of claim 9, further comprising at least one loop antenna,
wherein the at least one loop antenna is connected to the AC power supply in series or parallel.

16. The inductively coupled plasma generator of claim 9, wherein the loop antenna comprises a plurality of segments physically separated from each other and respectively including a plurality of first ends, second ends and antenna coil units, and
the first end and the second end of each of the segments are connected to the AC power supply and the ground terminal in parallel.

17. The inductively coupled plasma generator of claim 9, wherein the loop antenna is disposed to surround a curved surface of the outer wall of the chamber.

18. The inductively coupled plasma generator according to claim 9, wherein the loop antenna is disposed on a flat surface of the outer wall of the chamber.

19. The inductively coupled plasma generator of claim 9, wherein a height of the antenna coil unit is determined on the basis of a height of the outer wall of the chamber.

20. A method of driving an inductively coupled plasma generator, comprising:
introducing a gas for forming plasma into a chamber; and
supplying power of an alternating current (AC) power supply to one end of a loop antenna disposed on an outer wall of the chamber,
wherein the loop antenna comprises one or more sub-coil units arranged along a coil of the loop antenna,
the loop antenna generates an induced electric field in an inner region of the loop antenna in response to the power of the AC power supply, and
the one or more sub-coil units generate magnetic fields in a region adjacent to the coil of the loop antenna.

21. The method of claim 20, wherein the one or more sub-coil units are disposed to generate local magnetic fields whose N poles and S poles are alternately arranged in a longitudinal direction of the loop antenna.

22. The method of claim 20, wherein the one or more sub-coil units generate local magnetic fields whose N poles and S poles are symmetrically arranged in a direction substantially perpendicular to a longitudinal direction of the loop antenna.

23. The method of claim 21, wherein the one or more sub-coil units are configured so that the N poles and the S poles have lines of magnetic force of substantially the same magnitude.
